(19) United States
(12) Patent Application Publication
(10) Pub. No.: US 2020/0072366 A1
(43) Pub. Date: Mar. 5, 2020

(54) VALVE ASSEMBLY CAPABLE OF CONTROLLING FLOW DIRECTION OF FLUID ACCORDING TO TILT DIRECTION

(71) Applicant: Yong-Soo KIM, Changwon-si (KR)

(72) Inventor: Yong-Soo KIM, Changwon-si (KR)

(21) Appl. No.: 16/467,871

(22) PCT Filed: Feb. 2, 2017
(86) PCT No.: PCT/KR2017/001150

§ 371 Date: Jun. 7, 2019

(30) Foreign Application Priority Data
Dec. 7, 2016 (KR) 10-2016-0165819
Dec. 7, 2016 (KR) 10-2016-0165821
Dec. 7, 2016 (KR) 10-2016-0165830

(51) Int. Cl. F16K 15/18; F16K 15/04

(52) U.S. Cl. CPC F16K 15/183; F16K 15/042

(57) ABSTRACT

The present invention proposes a valve assembly in which the flow direction of a fluid is controlled according to a tilt angle and a large amount of fluid can be moved. The valve assembly of the present invention consists of: a valve body (10) provided thereinside with an inner passage through which a fluid can pass, and having a pair of access ports (12, 14) which are formed at positions opposite to each other to enable the fluid to flow in and out and are relatively long in the horizontal direction compared to the longitudinal direction, and a pair of seating portions (12a, 14a) which are respectively formed in an inner portion of the pair of access ports; a pair of connection portions (32, 34) which communicate with the pair of access ports and are connected so that the fluid can flow between the inside and the outside of the valve body; and one or a pair of check balls or check rollers (16A, 16B) for controlling the flow of the fluid from the inside of the valve body to the connection portions by being seated in or spaced from the seating portions of the valve body. Also, a stopper enables the fluid to flow within a predetermined range at the access ports where the check balls or check rollers have been assigned. Accordingly, one check ball or check valve can open and close only an assigned access port so that the flow direction of the fluid can be quickly and accurately controlled.

### TECHNICAL FIELD

The present invention relates to a valve assembly which interrupts a flow of a fluid, and more particularly, to a valve assembly which can control the flow direction of a fluid according to a tilt direction and is configured such that a large amount of fluid can flow.

### BACKGROUND ART

According to Korean Patent No. 10-1645319 of the present applicant, a valve which is installed in a shoe of a shoe such that the flow direction of a fluid can be controlled according to a tilt angle of the shoe is disclosed. However, in the conventional technology, the following disadvantages of use are considered.

Since the flow of a fluid is interrupted by using one check ball, an inner passage for the fluid, which is opened and closed by the one check ball has to be used. Accordingly, since the overall flow amount of the fluid is small, there is a difficulty in interrupting the fluid of a large capacity. Further, since the fluid is interrupted by using a check ball, it is considered that there is a limit in changing the shape of a device, to which the valve is applied. For example, efficiency is rather lowered when the flow of the fluid is interrupted for a wide area while having a relatively low height.

Further, in the conventional technology exemplified above, one check ball is selectively seated in ball seating parts on opposite sides according to a tilt direction. When the valve assembly is realized by one check ball in this way, since the movement range of the check ball may be increased to a value, which is more than a value by which the check ball normally reacts originally, by the flow velocity of the fluid, a disadvantage of badly influencing a precise operation of the valve assembly also can be expected. For example, the check ball in one seating part may be immediately moved to the seating part on the opposite side to be adhered to the seating part by a force of the fluid so that an error of an operation of the valve assembly may be generated.

### DETAILED DESCRIPTION OF THE INVENTION

### Technical Problem

The present invention provides a valve assembly which can control a flow direction thereof according to a tilt direction for a large amount of fluid.

The present invention also considers a structural environment at a part in which a valve assembly is installed, and provides a valve assembly which is installed at a part which requires an inner passage for a fluid, which is low and large in a horizontal direction, so that a large amount of fluid can flow.

The present invention also provides a valve assembly which can interrupt a flow of a large amount of fluid and by which the flow direction of the fluid can be accurately controlled.

The present invention also provides a valve assembly which can control the flow direction of the valve itself in a horizontal state.

### Technical Solution

In accordance with an aspect of the present invention, there is provided a valve assembly including: a valve body including an inner passage, through which fluid passes, in the interior thereof, and including a pair of access ports formed at opposite positions and through which the fluid is introduced, and a plurality of seating parts formed at inner parts of the access ports; a pair of connection parts communicating with the access ports, respectively, and connecting the inside and the outside of the valve body such that the fluid flows between the inside and the outside of the valve body; a pair of check rollers or check balls which are seated in or spaced apart from the seating parts of the valve body if the valve body is tilted to interrupt a flow of the fluid from the interior of the valve body to the connection parts; and a restriction unit configured to restrict movement ranges of the check rollers such that the check rollers or the check balls move on the seating parts within a predetermined range.

The restriction unit of the first embodiment of the present invention may include protruding stoppers protruding from the inner surface of the valve body by a predetermined size at positions, which are spaced apart from the seating parts inwards by a predetermined interval such that the check rollers or the check balls move only between the seating parts and the stoppers.

The restriction unit of the second embodiment of the present invention may include stoppers formed with mesh nets which partition portions of the interior of the valve body at positions which are spaced from the seating parts inwards by a predetermined interval.

The restriction unit of the third embodiment of the present invention may be formed with a mesh net which divides the inner passage of the valve body into two parts such that only the fluid passes through the mesh net while the check rollers or the check balls do not pass through the mesh net.

The restriction unit of the fourth embodiment of the present invention may include one stopper which protrudes while dividing the inner passage of the valve body into two parts, and the stopper has an extension height over which the check rollers or the check balls do not pass.

The restriction unit of the fifth embodiment of the present invention may include a pair of tubular stoppers which extend from the seating parts to the inside of the valve body and supports the check rollers or the check balls such that the fluid passes through the tubular stopper and the check rollers or the check balls move only in the interior of the tubular stoppers.

In the embodiment, the tubular stoppers may be formed to be tilted so that the flow direction of the fluid may be controlled even when the valve body is in a horizontal state.

The restriction unit of the sixth embodiment of the present invention may include a partition wall which partitions a first access port and a second access port in the interior of the valve body, and the partition wall includes a net body, through which the fluid passes and the check balls or the check roller do not pass.

According to another embodiment of the present invention, the valve assembly may further a prevention unit configured to prevent the check roller or the check balls from being adhered to the seating parts not by the tilt of the valve body but by the flow of the fluid in the interior of the valve body.

The prevention unit in the embodiment may be configured such that the stoppers at parts, in which the fluid presses the check rollers, have a blocked shape so that the check rollers move toward the valve seating parts.

### Advantageous Effects of the Invention

According to the present invention have the above configuration, the first access port and the second access port formed at the opposite positions can be opened and closed by the separate check balls or check rollers. Further, at the same time, the check balls and the check rollers can move only in the predetermined ranges by the restriction unit. Accordingly, since the fluid can be quickly and accurately interrupted by the check balls or the check rollers, the reliability for control of the flow direction of the fluid can be sufficiently improved. For example, since the check ball on one side can approach only the access port assigned thereto, it cannot approach the other opposite access port by an external force.

Further, according to the present invention, the prevention unit for preventing the check rollers or the check balls from being pushed and moved to the seating part by the flow of the fluid such that the flow direction of the fluid can be accurately controlled only by the tilt direction of the valve body is provided. Since the check rollers can be prevented more firmly from blocking the access ports, which are to be opened, by the flow of the fluid in a direction that is different from the inclination direction of the valve body, the reliability for control of the flow direction of the fluid can be further improved ultimately.

### DESCRIPTION OF THE DRAWINGS

FIG. 1 is a schematic perspective view illustrating a basic configuration of a valve body of the present invention.

FIG. 2 is a cross-sectional exemplary view illustrating a schematic configuration of the valve assembly of the present invention.

FIG. 3 is a longitudinal sectional exemplary view illustrating a schematic configuration of a valve assembly of another embodiment of the present invention.

FIG. 4 is a longitudinal sectional exemplary view exemplifying a flow of a fluid when the valve assembly of the present invention is tilted to one side.

FIG. 5 is a longitudinal sectional view illustrating an embodiment of a stopper in the valve assembly of the present invention.

FIG. 6 is a longitudinal sectional view illustrating another embodiment of the stopper in the valve assembly of the present invention.

FIG. 7 is a longitudinal sectional view illustrating another embodiment of the stopper in the valve assembly of the present invention.

FIG. 8 is an exemplary cross-sectional view of the valve assembly of the present invention realized in a valve body including four access ports.

FIG. 9 is a longitudinal sectional view illustrating another embodiment of the stopper in the valve assembly of the present invention.

FIG. 10 is a longitudinal sectional view illustrating another embodiment of the stopper in the valve assembly of the present invention.

FIG. 11 is a longitudinal sectional view illustrating another embodiment of the stopper in the valve assembly of the present invention.

FIG. 12 is a longitudinal sectional view illustrating another embodiment of the stopper in the valve assembly of the present invention.

FIG. 13 is a longitudinal sectional view illustrating another embodiment of the stopper in the valve assembly of the present invention.

### BEST MODE

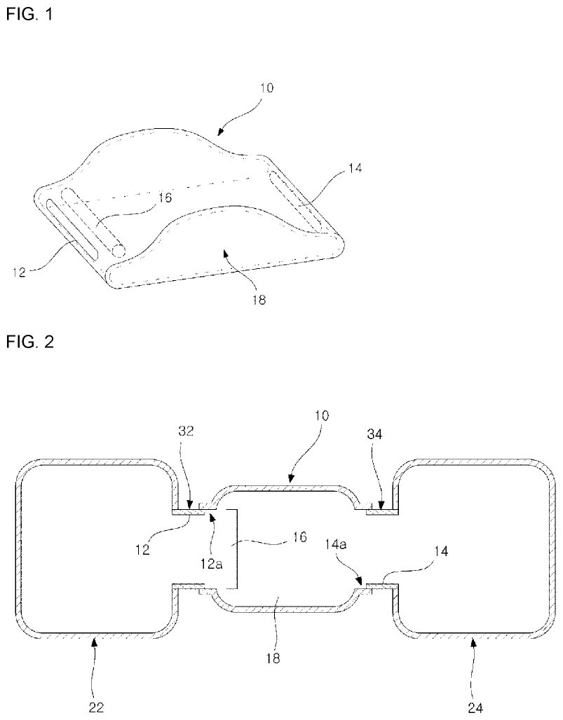

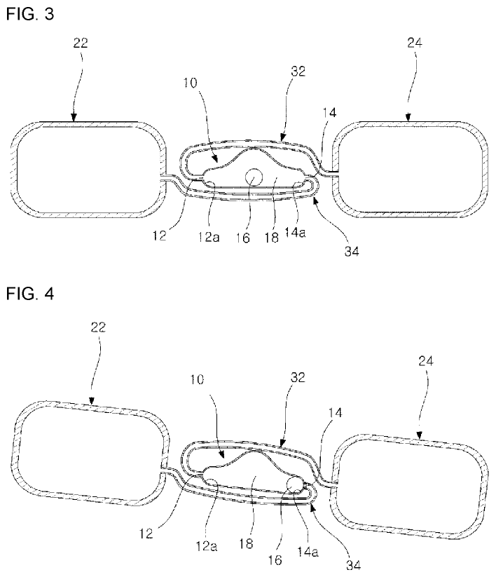

Hereinafter, the present invention will be described in more detail with reference to the embodiments illustrated in the drawings. First, the basic configuration of the present invention will be discussed with reference to FIGS. 1 to 3. Here, FIG. 1 is an exemplary perspective view for explaining the basic function of a valve body 10 of the present invention. FIG. 2 illustrates cross-sections of a valve body and a pair of fluid casings of the present invention. FIG. 3 illustrates longitudinal sections of the valve body and the pair of fluid casings of the present invention.

As illustrated in FIGS. 1 to 3, the valve body 10 of the present invention includes an inner passage 18, through which a fluid flows, in the interior thereof. Further, a pair of access ports 12 and 14 are formed at opposite positions of the inner passage 18. The access ports 12 and 14 are formed at opposite positions such that one access port 12 is located at a higher position and the other access port 14 is located at a relatively low position if the valve body 10 is tilted.

Further, in the present invention, the access ports 12 and 14 are formed to be closed or opened by check roller 16, and for example, the check roller is formed to extend horizontally in correspondence to the shapes of the access ports 12 and 14. In the present invention can be efficiently used when a large amount of fluid has to flow in a low structure as the access ports 12 and 14 are formed to extend horizontally to be opened or closed by the check roller 16.

As can be seen in FIG. 3 clearly, seating parts 12a and 14a, on which the check roller 16 may be seated, are formed inside the access ports 12 and 14, respectively. The seating parts 12a and 14a are provided such that the check roller 16 is seated in the seating parts 12a and 14a, and actually have shapes corresponding to the outer shape of the check roller 16. Accordingly, the inner surface of the check roller 16 and the valve body 10 are adhered to each other if the check roller 16 is seated in the seating parts 12a and 14a so that the fluid cannot flow in the interior of the valve body 10 to the outside through the access ports 12 or 14 on which the check roller 16 is seated.

For example, the left access port is referred to as a first access port 12, and the right access port is referred to as a second access port 14 in the drawings. As illustrated in FIG. 4, if the first access port 12 is located on the upper side and the second access port 14 is located on the lower side, the check roller 16 is spaced apart from the first seating part 12a by the self-weights and are seated in the second seating part 14a. Then, it becomes impossible for the fluid to flow from the interior of the valve body 10 to the second access port 14.

Further, as illustrated in FIGS. 2 and 3, the valve assembly according to the present invention may further include a pair of fluid casings 22 and 24 which may be connected to the first access port 12 and the second access port 14 by connection parts 32 and 34, respectively. The fluid casings 22 and 24 in the present invention may be containers which store the fluid which flows via the interior of the valve body 10, and if necessary, may be formed of a flexible material or may be formed of an elastically restorable material.

The fluid casings 22 and 24 are connected to the inner passage 18 in the interior of the valve body 10 through the connection parts 32 and 34, respectively. Here, the feature that the fluid casings 22 and 24 are connected to the inner passage 18′ that the fluid can flow from the fluid casings 22 and 24 into the interior of the valve body 10, and in more detail, also means that the fluid can flow from the first fluid casing 22 to the second fluid casing 24 via the valve body 10 or in the opposite direction.

According to the present invention, with the condition in which the fluid flows via the inner passage 18 of the valve body 10, the direction of the fluid from the first fluid casing 22 to the second fluid casing 24 or from the second fluid casing 24 to the first fluid casing 22 will be determined substantially according to the tilt direction of the valve body 10.

Here, the feature that the check roller 16 is spaced apart from the first seating part 12a by the self-weights and is seated in the second seating part 14a is that the check roller 16 is formed of a material having a high specific gravity as compared with the fluid. If the check roller 16 is formed of a material having a low gravity as compared with the fluid to have buoyancy, the flow of the fluid will be in the opposite direction.

Next, the condition of the flow directions of the fluid will be discussed in more detail. For reference, in the embodiment illustrated in FIG. 2, the connection parts 32 and 34 connect the access ports 12 and 14 to the fluid casings 22 and 24 which are relatively close to the access ports 12 and 14, and in the embodiments illustrated in FIGS. 3 and 4, the connection parts 32 and 34 connect the access ports 12 and 14 to the fluid casings 22 and 24 which are far from the access ports 12 and 14.

In a discussion based on the embodiments illustrated in FIGS. 3 and 4, it may be identified that the first access port 12 of the valve body 10 is connected to the second fluid casing 24 through the first connection part 32, and the second access port 14 of the valve body 10 is connected to the first fluid casing 22 through the second connection part 34. Further, as illustrated in FIG. 4, if the valve body 10 is tilted (rotated) in a state in which the right side is low, the check roller 16 will be adhered to the second seating part 14a. Here, the check roller 16 has a specific gravity that is higher than that of the fluid in the interior of the valve body 10 and thus heavier than the fluid so that it submerged to the lowest site.

In this way, as in the state illustrated in FIG. 4, it becomes impossible for the fluid to move to the second connection part 34 in the interior of the valve body 10. However, it is possible for the fluid to move to the first connection part 32 in the interior of the valve body 10. Further, in the state illustrated in FIG. 4, the first access port 12 is connected to the second fluid casing 24 through the first connection part 32, and the second access port 14 is connected to the first fluid casing through the second connection part 34.

Accordingly, this state is a state in which the fluid can flow from the first fluid casing 22 to the second fluid casing 24 via the interior of the valve body 10, and is a state in which the fluid cannot flow in the opposite direction. In this way, it can be seen that the flow direction of the fluid in the valve assembly of the present invention is determined substantially by the tilt direction of the valve body 10. That is, the fluid can flow from the second connection part 34 of a low position to the first connection part 32 of a high position, and cannot flow in the opposite direction.

As illustrated in FIG. 4, if the second access port 14 and the first fluid casing 22 are connected to each other through the second connection part 34 and the first access port 12 and the second fluid casing 24 are connected to each other through the first connection part 32, the fluid can flow only in a direction from the connection part 14 of the low position to the connection part 12 of the high position.

Further, as illustrated in FIG. 2, in a state in which the first access port 12 is connected to the first fluid casing 22 through the first connection part 32 and the second access port 14 is connected to the second fluid casing 24 through the second connection part 34, the fluid can flow from the second connection part 34 at the lower position to the first connection part 32 at the higher position and cannot flow in the opposite direction if the second access port 14 is located at a position which is lower than the first fluid access port 12. That is, the fluid can flow only from the second fluid casing 24 to the first fluid casing 22.

In the above-mentioned embodiment, it has been described that the check roller 16 is formed of a material, of which the specific gravity is higher than that of the fluid, that is, the check roller 16 has a submersion force. However, it may be considered that the check roller 16 itself is formed of a material, of which the specific gravity is lower than the fluid that passes through the interior of the valve body 10 and has buoyancy. If the check roller 16 is formed of a material having buoyancy to the fluid, the check roller 16 will be adhered to, among the seating parts 12a and 14a, the seating part at the higher position if the valve body 10 is tilted. Accordingly, the fluid can flow from the connection pat 32 or 34 at the higher position to the connection part 34 or 32 at the lower position, but the flow of the fluid in the opposite direction is restricted.

The above description is about how the flow direction of the fluid with respect to the tilt direction of the valve body 10 of the present invention is determined. Hereinafter, a valve assembly of the present invention, which is based on the principle but includes a pair of check rollers such that the seating parts assigned to the check rollers, respectively, may be accurately opened and closed will be discussed. That is, the detailed embodiment of the present invention may be an embodiment of setting the number of the check rollers 16 is set to correspond to the number of the access ports 12 and 14, and the check rollers 16 will be realized in the form of check balls according to the shapes of the access ports.

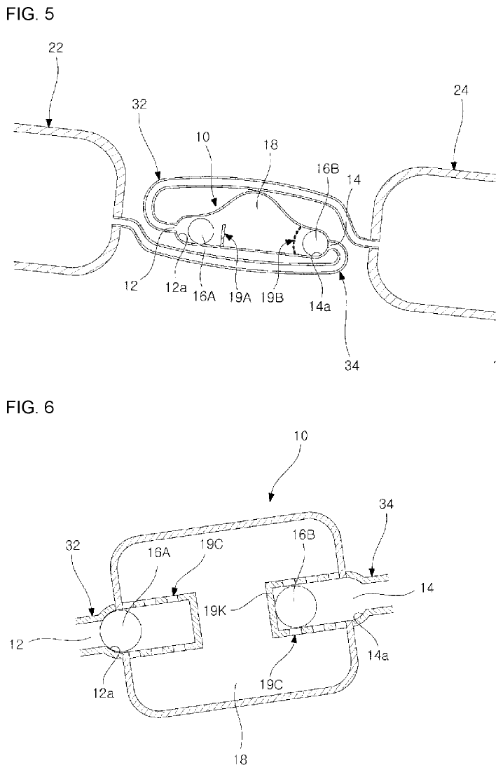

As illustrated in FIG. 5, the pair of access ports 12 and 14 are formed at opposite positions of the inner passage 18 of the valve body 10, and the access ports communicate with the connection parts 32 and 34. Further, the connection parts 32 and 34, for example, are connected to the fluid casings 22 and 24. In the illustrated embodiment, it can be identified that the first access port 12 is connected to the second fluid casing 24 through the second connection part 32 and the second access port 14 is connected to the first fluid casing 22 through the second connection part 34.

Further, the pair of check rollers 16A and 16B are provided in the interior of the valve body 10. The first check roller 16A is adapted to open and close the first seating part 12a and the second check roller 16B is adapted to open and close the second seating part 14a. If the seating parts 12a and 14a are configured to be independently opened and closed by using the pair of check rollers 16A and 16B in this way, it is apparent that the access ports 12 and 14 may be controlled to be opened and closed more accurately and quickly, and one check roller 16A can be prevented from blocking the access port 14 assigned to another check roller 16B.

In the present invention, the check rollers 16A and 16B are installed to move only in a predetermined movement range. According to the embodiment of FIG. 5, it can be seen that a stopper 19A having a simple boss shape or a wall shape is installed around the first check roller 16A. The stopper 19A prevents the first check roller 16A from entering the second seating part 14a on the opposite side by restricting the movement of the first check roller 16A in the inner passage 18 of the valve body 10 to a specific interval or less.

Accordingly, it is sufficient only if the stopper 19A has a height (protrusion length) by which the first check roller 16A cannot be move to the outside further in the inner passage 18 of the valve body 10. Further, it can be seen that the stopper 19A of the illustrated first embodiment includes a wall shaped stopper protruding and extending from the bottom surface of the inner passage 18 by a predetermined height.

Further, the movement of the second check roller 16B is also restricted to a range with a predetermined distance from the second seating part 14a by the stopper 19B. Here, the stopper 19B includes a mesh net such that the fluid can pass through the stopper 19B but the check roller 16B cannot pass through the stopper 19B to restrict the movement of the second check roller 16B around the second seating part 14a. Accordingly, it can be seen that the second check roller 16B can move only between the second seating part 14a and the stopper 19B. The stopper 19B of the illustrated second embodiment includes a mesh net which partitions a portion of the inner passage of the valve body such that the check roller 16B can move within a predetermined interval which is spaced apart inwards from the access port 14.

As can be seen from the above description, it can be seen that the stopper 19A and the stopper 19B are installed such that the check rollers 16A and 16B can move within a predetermined distance from the seating parts 12a and 14a, respectively. Accordingly, it can be seen that the stopper 19A and the stopper 19B function as check roller restricting unit which restrict the movement ranges of the check rollers.

FIG. 6 is a longitudinal sectional view illustrating another embodiment of the present invention, and illustrates stoppers 19C of another embodiment. The stoppers 19C of the present embodiment has tubular shape extending from the access ports 12 and 14 into the interior of the valve body, and the check rollers 16A and 16B include mesh nets or a plurality of bar assemblies which can move only in predetermined zones. Accordingly, as illustrated, if the access port 12 on the left side is located at a relatively low position in the drawing, the first access port 12 is blocked by the first check roller 16A and the second access port 14 is opened as the second check roller 16B is spaced apart from the second access port 14.

The stoppers of the embodiment illustrated in FIG. 6 have tubular shapes in which the check rollers 16A and 16B can move by a predetermined distance, and it can be seen that the stoppers 19C extend inwards from the access ports 12 and 14 and the check rollers have to be located in the interior of the stoppers 19C even if the check rollers are spaced apart from the seating parts.

In this state, the fluid can flow from the first connection part 32, to the inner passage 18 of the valve body 10 and then to the second connection part 34, but the flow of the fluid in the opposite direction is restricted. Here, in this state, that is, in the state in which the fluid can flow from the left side to the right side in the drawing, if the second check roller 16B blocks the second access port 14 at the higher position by the flow of the fluid flowing to the second connection part 34 in the inner passage 18 of the valve body 10, the overall operation of the valve assembly can be problematic.

Accordingly, the check roller 16B should be prevented from moving by the flow of the fluid in the interior of the valve body 10 to block the access port 14 at the higher position. To achieve this, for example, closed parts 19K are provided at positions of the stopper 19C at which the fluid may press the check rollers 16A and 16B toward the access ports 12 and 14 or the seating parts.

With the same principle, in FIG. 5, it is apparent that it is preferable that the stoppers 19A also have protruding portions having a predetermined height or wall portions so that the check roller 16A is configured not to receive the flow of the fluid facing the first access port 12.

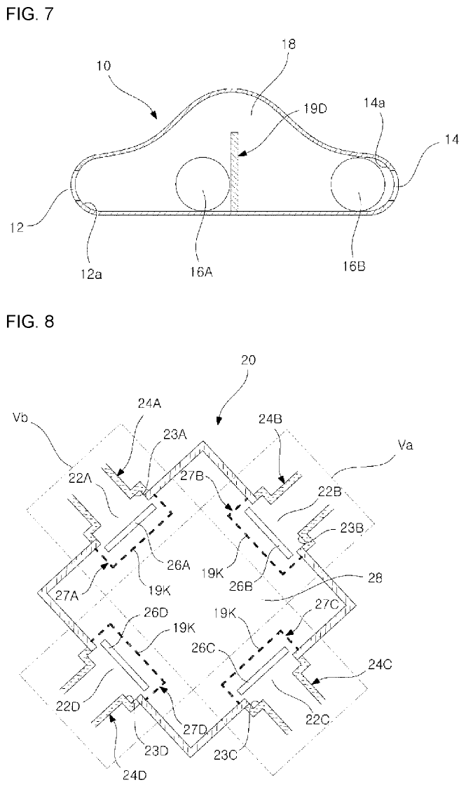

Further, FIG. 7 illustrates a stopper 19D of another embodiment. In the illustrated embodiment, it can be seen that a wall shaped stopper 19D extending from a central portion of the inner passage 18 of the valve body 10 by a predetermined height is exemplified. In this case, it is preferable that the height of the stopper 19D is determined such that the check roller 16A and 16B on one side does not pass over the stopper 19D. Further, a net body which divides the inner passage 18 of the valve body 10 into two parts may be provided instead of the stopper 19D.

As discussed above, with the assumption that a pair of access ports 12 and 14 formed at opposite positions of the valve body and a pair of check rollers 16A and 16B which independently open and close the access ports 12 and 14 are provided, it can be seen that the stopper 19D of the present invention limits the movement ranges of the check rollers at the access ports such that only the corresponding access port may be opened and closed. Here, it can be seen that the check rollers should open and close the access ports while moving on the basis of the tilt direction of the valve body, and the stoppers are not allowed to open and close the access ports with the influence of the fluid in the inner passage in the interior of the valve body.

Further, in order that the check roller does not influence the opening and closing of the access port with the influence of the flow of the fluid, the stopper may be designed to have various shapes. For example, as illustrated in FIG. 6, in order that the check rollers 16A and 16B do not react the flow of the fluid flowing toward the access ports 12 and 14, various changes of design, such as blocking of the closed parts, may be made.

Next, another embodiment of the present invention will be discussed on the basis of FIG. 8. The present embodiment is an embodiment in which two valve bodies, which have been described above, are combined. As illustrated in FIG. 8, it may be an embodiment in which a first valve assembly Va including a pair of access ports 22B and 22D and a pair of check rollers 26B and 26D and a second valve assembly Vb including a pair of access ports 22A and 22C and a pair of check rollers 26A and 26C are combined.

Here, if the first valve assembly Va and the second valve assembly Vb are separated, they have the configuration and operation that are substantially the same as described above. Further, by combining the two valve assemblies in this way, one valve body 20 including the inner passage 28 includes a first access port 22A, a second access port 22B, a third access port 22C, and a fourth access port 22D, and a first check roller 26A, a second check roller 26B, a third check roller 26C, and a fourth check roller 26D which open and close the access ports, respectively. Further, stoppers 27A, 27B, 27C, and 27D for restricting the movement of the check rollers to predetermined ranges are installed inside the access ports 22A, 22B, 22C, and 22D, respectively.

If the valve body 20 is tilted to one side, for example, the first access port 22A and the second access port 22B are located at heights which are higher than the third access port 22C and the fourth access port 22D, the first check roller 26A and the second check roller 26B are spaced apart from the seating parts 23A and 23B of the first access port 22A and the second access port 22B so that the first access port 22A and the second access port 22B are maintained in an opened state. Further, the third check roller 26C and the fourth check roller 26D are seated in the seating parts 23C and 23D of the third access port 22C and the fourth access port 22D so that the third access port 22C and the fourth access port 22D are maintained in a closed state.

In this state, the fluid can flow from the third connection part 24C and the fourth connection part 24D to the interior of the inner passage of the valve body 20, and cannot flow from the interior of the valve body 20 to the third connection part 24C and the fourth connection part 24D. Accordingly, as a whole, the fluid can flow from the fluid casings connected to the third connection part 24C and the fourth connection part 24D into the interior of the valve body 20, and then, can flow from the interior of the valve body to the fluid casings connected to the first connection part 24A and the second connection part 24B through the first connection part 24A and the second connection part 24B.

Further, it can be seen that the complex valve assembly is constructed by complexly combining two valve assemblies having a pair of opposite access ports, and it can be seen that in the operation of the complex valve assembly, the fluid can flow only in one direction through a plurality of access ports. Further, it is apparent that even in the embodiment, the plurality of check rollers are controlled to move only within a predetermined range by the stoppers.

In the description of the present invention, it can be seen that the access ports are formed to extend leftwards and rightwards rather than upwards and downwards, and the access ports having the shapes are configured to opened and closed by the check rollers. However, it is apparent that the shapes of the check rollers may be changed according to the shapes of the access ports. For example, when the access ports are formed to have simple circular holes, check balls may sufficiently realize the opening and closing operation. That is, it is apparent that the above-described check rollers may be replaced by check balls according to the shapes of the access ports.

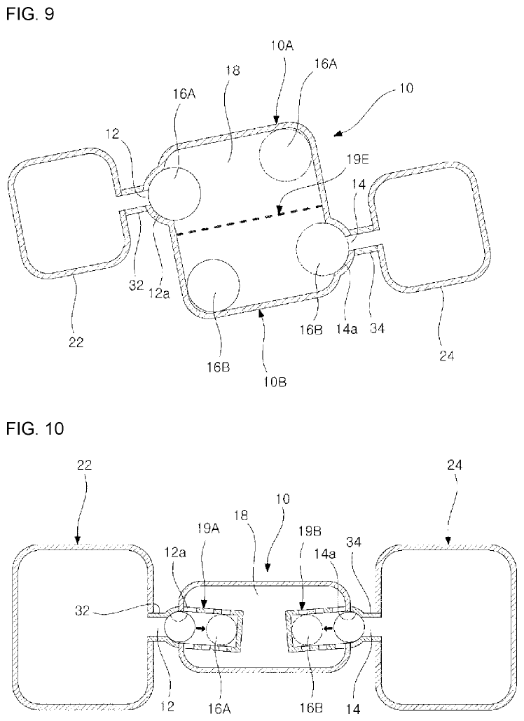

The embodiment described below is an embodiment in which the check balls are used instead of the above-mentioned check rollers. As illustrated in FIG. 9, the first access port 12 and the second access port 14 are formed at opposite portions of the valve body 10 of the present embodiment, but the first access port 12 and the second access port 14 are not arranged on the same axis. Further, the first check ball 16A and the second check ball 16B are installed to move within a predetermined range, and have movement ranges which overlap each other vertically so that the interval between the access ports 12 and 14 may be short. Further, the seating parts 12a and 14a are formed on the inner surfaces of the access ports 12 and 14.

As illustrated, it can be seen that the first access port 12 is formed on one side of the valve body 10 and the second access port 14 is formed on an opposite side of the valve body 10 so that the pair of access ports 12 and 14 are located at substantially opposite positions (or opposed positions). Further, a partition wall 19E which divides an inner space provided with the first access port 12 and the second access port 14 is installed transversely at a central portion of the valve body 10. That is, the partition wall 19E may be a partition which partitions the first access port 12 and the second access port 14, and the partition wall 19E includes a net body such that the fluid can pass through the partition wall 19E but the check balls 16A and 16B cannot pass through the partition wall 19E.

A pair of check balls 16A and 16B for independently opening and closing the access ports 12 and 14 are contained in the interior of the valve body 10. Here, it can be seen that the movement distance of the first check ball 16A is determined by the partition wall 19E and a portion of the casing 10, and the movement distance of the second check 16B is determined by the partition wall 19E and another portion 10B of the casing 10.

Accordingly, it can be seen in the present embodiment that the partition wall 19E and the portion 10A or 10B of the valve body function as a check ball restricting unit for substantially restricting the movement distances of the check balls 16A and 16B. Further, the partition wall 19E is formed of a structure, through which the fluid can pass, and for example, may be formed of a net body.

Further, as illustrated in FIG. 9, if the valve body 10 is tilted such that the left side of the valve body 10 is lower, the check balls 16A and 16B formed of a material, of which the specific gravity is higher than that of the fluid, is adhered to the seating part 12a on the left side of the valve body 10 as indicated by a solid line. Accordingly, the valve body 10 is brought into a state in which the fluid cannot flow from the inner passage 18 of the valve body 10 to the first access port 12 and can flow from the inner passage 18 of the valve body 10 only to the second access port 14.

The fact means that the fluid can flow from the first fluid casing 22 connected to the first access port 12 though the connection part 32 to the second fluid casing 24 connected to the second access port 22 through the connection part 34 via the inner passage 18 of the valve body 10. Further, in this state, the fluid cannot flow in the opposite direction.

Even in the present embodiment, it can be seen that the fluid can flow only in one direction according to the tilt direction of the valve body 10. Here, another embodiment may be considered, and it may be considered that the pair of check balls 16A and 16B, which have been described above, are formed of a material, of which the specific gravity is lower than that of the fluid, and have buoyancy.

If the pair of check balls 16A and 16B have buoyancy in this way, the fluid can flow only in the opposite direction in the state of the tilt as in FIG. 9. That is, it will be understood that as indicated by a dot-long dash line, since the check ball 16B having buoyancy is adhered to the seating part 14a, which is adjacent to the second connection part 34, in the tilt direction illustrated in FIG. 4 in the interior of the valve body 10, the fluid cannot flow from the interior of the valve body to the second connection part 34 and can flow only from the interior of the valve body 10 to the first connection part 32.

As discussed above, it can be seen that the check ball restricting unit which prevents one check ball from being seated in the seating part assigned to another check ball by restricting the movement of the check ball to a predetermined range or less in the present invention includes a pair of access ports 12 and 14 formed at opposite positions, and a partition wall 19E, through which the fluid can pass, is provided with the assumption of the pair of check balls 16A and 16B which independently open and close the access ports.

Here, even in the present embodiment, it can be seen that the check balls should open and close the access ports while moving on the basis of the tilt direction of the valve body, and the check balls are not allowed to open and close the access ports with the influence of the fluid in the inner passage in the interior of the valve body.

Next, another embodiment will be discussed with reference to FIG. 10. The present embodiment is a modified form of the embodiment illustrated in FIG. 6, and is configured such that the flow direction of the fluid may be controlled in the horizontal state of the valve body 10. As illustrated in FIG. 10, the valve body 10 of the present embodiment includes an inner passage 18, through which the fluid can flow, in the interior thereof, and a pair of access ports 12 and 14 are formed at opposite positions of the inner passage 18.

Further, the pair of access ports 12 and 14 of the present invention are configured to be independently closed or opened by the pair of check balls 16A and 16B. Ball seating parts 12a and 14a, on which the check balls 16A and 16B may be seated, are formed at inner portions of the access ports 12 and 14 of the valve body 10. The ball seating parts 12a and 14a are provided such that the check rollers 16 are seated in the ball seating parts 12a and 14a, and have shapes corresponding to the outer shapes of the check balls 16A and 16B.

Accordingly, if the check balls 16A and 16B are seated in the ball seating parts 12a and 14a, the check balls 16A and 16B and the ball seating parts 12a and 14a are adhered to each other. In this state, the fluid cannot flow from the inner passage 18 of the valve body 10 to the outside through the access ports 12 or 14, on which the check balls 16A and 16B are seated. However, as described above, the fluid can be introduced into the interior of the valve body 10 in any of the connection parts 32 and 34 connected to the access ports 12 and 14.

Further, the valve assembly according to the present invention may further include a pair of fluid casings 22 and 24 which may be connected to the first access port 12 and the second access port 14 by connection parts 32 and 34, respectively. The fluid casings 22 and 24 in the present invention may be containers which store the fluid which flows via the interior of the valve body 10, and if necessary, may be formed of a flexible material or may be formed of an elastically restorable material.

The fluid casings 22 and 24 are connected to the inner passage 18 in the interior of the valve body 10 through the connection parts 32 and 34, respectively. Here, the feature that the fluid casings 22 and 24 are connected to the inner passage 18 means that the fluid may flow from the fluid casings 22 and 24 into the interior of the valve body 10, and in more detail, also means that the fluid may flow from the first fluid casing 22 to the second fluid casing 24 via the valve body 10 or in the opposite direction.

In the present invention, the pair of check balls 16A and 16B also are installed to move only in a predetermined movement range. The present embodiment is the same as the embodiment illustrated in FIG. 6 in that the check ball restricting unit which restricts the movement of the check balls to predetermined ranges or less includes stoppers 19A and 19B formed in tubular shapes.

Accordingly, in the present embodiment, the pair of check balls 16A and 16B can move only in the interior of the pair of tubular stoppers 19A and 19B. Further, the first stopper 19A and the second stopper 19B have tubular shapes extending from the access ports 12 and 14 to the inside, and include mesh nets or a plurality of bar assemblies so that the fluid may pass through the first stopper 19A and the second stopper 19B. Further, it is the same as the embodiment of FIG. 6 that the flow direction of the fluid is controlled according to the tilt of the valve body 10.

The stoppers 19A and 19B of the present invention have substantially small tilts. The left stopper 19A has a tilt, the right side of which is lower, and the right stopper 19B has a tilt, the left side of which is lower. The tilt angles of the stoppers 19A and 19B themselves are very small, for example, are angles of 2° to 10°.

The tilts of the stoppers 19A and 19B are provided to space the check balls 16A and 16B apart from the ball seating parts 12a and 14a when the valve body 10 is in a horizontal state. Further, if the valve body 10 is tilted, the tilt angle of the valve body 10 when the flow of the fluid is controlled only in one direction should be larger than the tilt angles of the stoppers 19A and 19B.

The tilt degrees of the stopper 19A and 19B themselves are provided such that the check balls 16A and 16B are spaced apart from the access ports 12 and 14 when the valve body 10 is in a horizontal state, and the operation may be sufficiently performed even if the tilt degrees of the stopper 19A and 19B are very small. For example, the stoppers 19A and 19B are formed to have tilts of 2° to 5°, the check balls 16A and 16B are spaced apart from the access ports 12 and 14 in a state in which the valve body is maintained in a horizontal state. That is, the check balls 16A and 16B are moved downwards by the submersion forces thereof, and both the access ports 12 and 14 are opened.

In this way, the fact that both the access ports 12 and 14 are opened in the horizontal state of the valve body 10 means that the fluid can flow from the first fluid casing 22 to the second fluid casing 24 and also can flow in the opposite direction. Here, it can be seen that the configuration of opening both the access ports 12 and 14 in the horizontal state of the valve body 10 is achieved by the tilt angles of the stoppers 19A and 19B and as in the illustrated embodiment, is based on the fact that the inner ends (ends facing the interior of the valve body) of the stoppers 19A and 19B have tilts to be located at positions, which are lower than the access ports 12 and 14.

Further, if the valve body 10 itself is tilted at an angle (for example, at 5 degrees) which is larger than the tilt angles (for example, 2 degrees) of the stoppers even when the stoppers 19A and 19B are tilted at a small tilt angle, the valve body 10 may be configured such that the fluid can flow only in one direction on the basis of the tilt angle as described above and this is the same as the embodiment of FIG. 6.

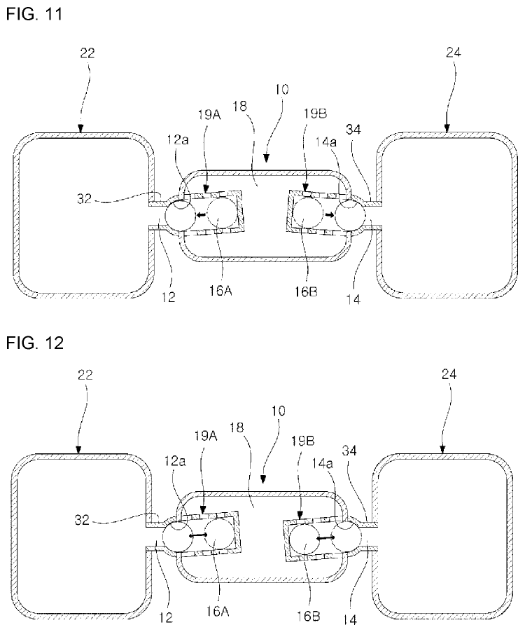

Further, it can be seen in the description of the embodiment illustrated in FIG. 11 that the stoppers 19A and 19B are tilted in directions which are opposite that of the embodiment of FIG. 10. That is, it can be seen that the stoppers 19A and 19B are tilted such that the inner ends (the ends facing the interior of the valve body) of the stoppers 19A and 19B are formed at positions which are higher than the access ports 12 and 14. In the embodiment, it can be seen that if it is assumed that the check balls 16A and 16B have a submersion force, the pair of check balls 16A and 16B are adhered to the ball seating parts 12a and 14a in the horizontal state of the valve body 10.

Further, if the check balls 16A and 16B block the access ports 12 and 14, the fluid substantially cannot flow to any side. That is, according to the present embodiment, it can be seen that the fluid cannot flow via the interior of the valve body 10 since the check balls 16A and 16B block the access ports 12 and 14 in the horizontal state of the valve body 10. The valve assembly will be used at a portion at which the flow of the fluid is not allowed in the horizontal state of the valve body.

Next, the embodiment illustrated in FIG. 12 will be discussed. The left stopper 19A is tilted such that the inner end of the left stopper 19A is located at a position which is higher than the access port 12, and the right stopper 19B is tilted such that the inner end of the left stopper 19B is located at a position which is lower than the access port 14. Accordingly, in the horizontal state of the valve body 10, the first check ball 16A is adhered to the first seating part 12a and the second check ball 16B is spaced apart from the second seating part 14a.

The state means that the fluid can flow substantially from the first fluid casing 22 to the interior of the valve body 10 through the connection part 32 and from the interior of the valve body 10 to the second fluid casing 24 through the connection part 34. However, the flow of the fluid in the opposite direction is impossible, and this is because the fluid cannot flow from the interior of the valve body 10 to the connection part 32 since the first check ball 16A blocks the first ball seating part 12a.

As discussed above, it can be seen that the flow direction of the fluid can be controlled in the horizontal state of the valve body according to the tilt directions of the stoppers 19A and 19B. However, since the tilts of the stoppers 19A and 19B are small as compared with the tilt angle of the valve body, the flow direction of the fluid can be controlled proprietarily as mentioned above if the valve body 10 itself is tilted.

As discussed above, it can be seen in the present invention that the ranges of the stoppers 19A and 19B are restricted such that the check balls 16A and 16B may move from the ball seating parts 12a and 14a within predetermined ranges and the check balls 16A and 16B perform a function of forming the paths. Accordingly, within the scope of performing the function, the detailed shapes and structures of the stoppers 19A and 19B may be variously modified.

In summary of the embodiments, the tubular stoppers for restricting the movement ranges of the check balls are formed to be tilted, and in FIG. 10, the stoppers are tilted such that the inner ends of the pair of stoppers are located at lower positions and the outer ends (the ends on the seating part side) of the stoppers are located at higher positions. Further, in FIG. 11, the pair of stoppers are tilted such that the inner ends of the stoppers are higher than the outer ends of the stoppers, and in FIG. 12, the pair of stoppers are formed such that the inner end of the stopper on one side is higher than the outer end of the stopper and the inner end of the stopper on the other side is lower than the outer end of the stopper.

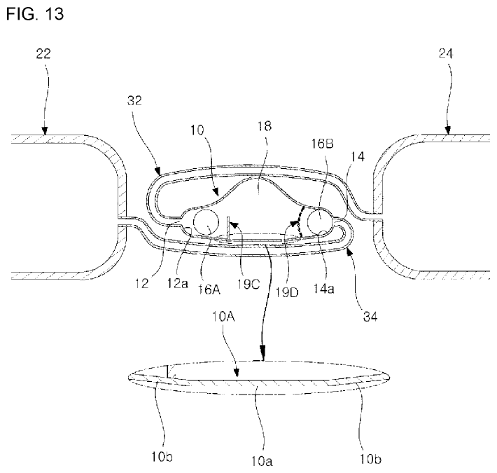

Next, a stopper according to another embodiment illustrated in FIG. 13 will be discussed. According to the present embodiment, opposite ends of the bottom surface of the inner passage 18, which are connected to the ball seating parts 12a and 14a, have tilted surfaces 10b. Further, a horizontal surface 10a is formed between opposite tilted surfaces 10b of the bottom surface of the inner passage 18.

The movement of the second check roller 16B installed on the right side of FIG. 13 is restricted to a range with a predetermined distance from the second seating part 14a by the stopper 19D. Here, the stopper 19D includes a mesh net such that the fluid can pass through the stopper 19B but the check ball 16B cannot pass through the stopper 19B to restrict the movement of the second check ball 16B around the second seating part 14a.

Even in the embodiment, in a state in which the valve body 10 is horizontal, the first check ball 16A and the second check ball 16B have substantially the same function as the embodiment illustrated in FIG. 10 since the first check ball 16A and the second check ball 16B are spaced apart from the first ball seating part 12a and the second ball seating part 14a by the tilted surfaces 10b.

Further, the tilted surfaces 10b on the opposite sides in the embodiment of FIG. 13 may be tilted surfaces which become lower as they go to the inner side, and may be tilted surfaces which become higher as they go to the inner side. If the pair of tilted surfaces 10b, which become higher as they go to the inside in the way, they have substantially the same function as the embodiment illustrated in FIG. 11.

In the embodiment illustrated in FIG. 13, it can be seen that the pair of stoppers 19C and 19D are provided to restrict the movements of the check balls 16A and 16B. However, one stopper may be installed, for example, a wall shaped stopper installed at an inner intermediate portion of the valve body 10 at a predetermined height may be provided, and may include a partition which divides the inner passage with a mesh net in an inner intermediate portion of the valve body 10.

As discussed above, the stopper in the present invention performs a function of restricting the movement of the check ball, and as in the present invention, it can be seen that the movement of the check balls at the access ports is limited by the stopper such that only the corresponding access port may be opened and closed with the assumption that the pair of access ports 12 and 14 formed at opposite positions and the pair of check balls 16A and 16B which independently open and close the access ports, respectively, are provided.

Here, it can be seen that the check balls should open and close the access ports while moving on the basis of the tilt direction of the valve body, and the check balls are not allowed to open and close the access ports with the influence of the fluid in the inner passage in the interior of the valve body.

Here, in order that the check ball does not influence the opening and closing of the access port with the influence of the flow of the fluid, the stopper may be designed to have various shapes. For example, as in the embodiment illustrated in FIG. 1, in order that the check balls 16A and 16B do not react the flow of the fluid flowing toward the access ports 12 and 14, various changes of design, such as blocking of the closed parts, may be made.

In the embodiment, it can be seen that the check balls are substantially adhered to or spaced apart from the seating parts to open and close the access ports. Here, the check balls in the illustrated embodiment are adapted to open and close the access ports having circular cross-sections, and as described above, it is possible to properly change the shapes of the check balls according to the shapes (for example, the cross-sectional shapes) of the access ports.

For example, it is apparent that it is preferable that when the horizontal widths of the access ports are significantly larger than the vertical heights thereof unlike the above-mentioned embodiments, the check balls for open and close the access ports substantially have the roller shapes. It is preferable that the check balls in this case has a roller shape to be realized by check rollers. Further, according to the fact, the check balls of the present invention can be modified to have a shape, which is suitable for closing of the access ports according to the shapes of the access ports, and as described above, the check balls and the check valves are substantially equivalent configurations.

According to the present invention, which has been discussed above, it can be seen that the check balls for opening and closing the access ports by using the stoppers can move within a predetermined distance, and the flow of the fluid can be controlled when the valve body is in a horizontal state by using the tilts of the stoppers at the same time.

### INDUSTRIAL APPLICABILITY

The valve assembly of the present invention as described above can be inserted into soles of shoes, for example, by making the valve assembly small. If the valve assembly is inserted into the soles of the shoes, the height of the shoes can be changed by expanding any one of the fluid casings high according to the load of a person and selecting one of the front and rear sides of the shoes according to a contour on which the person walks. Further, if the valve assembly is made large, the direction of the flowing fluid can be easily according to a rotational angle or an tilt direction so that it is expected that the valve assembly can be applied to various industrial fields.

1. A valve assembly comprising:
a valve body including an inner passage, through which fluid passes, in an interior thereof, and including a pair of access ports formed at opposite positions and through which the fluid is introduced, and a plurality of seating parts formed at inner parts of the access ports;
a pair of connection parts communicating with the access ports, respectively, and connecting the inside and the outside of the valve body such that the fluid flows between the inside and the outside of the valve body;
a pair of check rollers or check balls which are seated in or spaced apart from the seating parts of the valve body when the valve body is tilted to interrupt a flow of the fluid from the interior of the valve body to the connection parts; and
a restriction unit configured to restrict movement ranges of the check rollers such that the check rollers or the check balls move on the seating parts within a predetermined range.

2. The valve assembly of claim 1, wherein the restriction unit includes protruding stoppers protruding from the inner surface of the valve body by a predetermined size at positions, which are spaced apart from the seating parts inwards by a predetermined interval such that the check rollers or the check balls move only between the seating parts and the stoppers.

3. The valve assembly of claim 1, wherein the restriction unit includes stoppers formed with mesh nets which partition portions of the interior of the valve body at positions which are spaced from the seating parts inwards by a predetermined interval.

4. The valve assembly of claim 1, wherein the restriction unit is formed with a mesh net which divides the inner passage of the valve body into two parts such that only the fluid passes through the mesh net while the check rollers or the check balls do not pass through the mesh net.

5. The valve assembly of claim 1, wherein the restriction unit includes one stopper which protrudes while dividing the inner passage of the valve body into two parts, and the stopper has an extension height over which the check rollers or the check balls do not pass.

6. The valve assembly of claim 1, wherein the restriction unit includes a pair of tubular stoppers which extend from the seating parts to the inside of the valve body and supports the check rollers or the check balls such that the fluid passes through the tubular stopper and the check rollers or the check balls move only in the interior of the tubular stoppers.

7. The valve assembly of claim 6, wherein the tubular stoppers are formed to be tilted.

8. The valve assembly of claim 1, wherein the restriction unit includes a partition wall which partitions a first access port and a second access port in the interior of the valve body, and the partition wall includes a net body, through which the fluid passes and the check balls or the check roller do not pass.

9. The valve assembly of any one of claims 1 to 8, further comprising:
a prevention unit configured to prevent the check roller or the check balls from being adhered to the seating parts not by the tilt of the valve body but by the flow of the fluid in the interior of the valve body.

10. The valve assembly of claim 9, wherein the prevention unit is configured such that the stoppers at parts, in which the fluid presses the check rollers, have a blocked shape so that the check rollers move toward the valve seating parts.
